(19) United States
(12) Patent Application Publication
(10) Pub. No.: US 2008/0190851 A1
(43) Pub. Date: Aug. 14, 2008

(54) Crosslinkable Materials Based on Organosilicon Compounds

(75) Inventor: Johann Muller, Konzell (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/815,811

(22) PCT Filed: Jan. 26, 2006
(86) PCT No.: PCT/EP2006/000693

§ 371 Date: Aug. 8, 2007

(30) Foreign Application Priority Data
Feb. 8, 2005 (DE) 10 2005 005 634.2

(51) Int. Cl. B01J 39/00

(52) U.S. Cl. 210/660

(57) ABSTRACT

The invention relates to crosslinkable materials based on organosilicon compounds which contain acid scavengers, moldings produced therefrom by crosslinking and the use of these moldings for absorbing and neutralizing acids in a liquid or gaseous medium.

The invention relates to crosslinkable materials based on organosilicon compounds, moldings produced therefrom by crosslinking and the use of these moldings for absorbing and neutralizing acids.

Crosslinkable materials based on organosilicon compounds having different types of fillers and additives are widely known. In this context, reference may be made, for example, to EP-B 841 377, which describes in particular organopolysiloxane materials which, after crosslinking, give vulcanizates having a surface dry to the touch.

The invention relates to crosslinkable materials based on organosilicon compounds, characterized in that they contain acid scavengers.

The acid scavengers present in the materials according to the invention may be any desired substances which are capable of neutralizing acids.

Examples of acid scavengers are metal oxides, such as aluminum oxide, zinc oxide, calcium oxide and magnesium oxide, metal hydroxides of the 2nd and 3rd main group and 2nd subgroup, such as aluminum hydroxide, zinc hydroxide, calcium hydroxide and magnesium hydroxide and the hydrates thereof; salts of weak acids with strong bases, such as zinc carbonate, calcium carbonate and magnesium carbonate and the corresponding bicarbonates, ammonium salts, such as ammonium carbonate and ammonium bicarbonate; organic substances which can neutralize acids, such as urea and tetramethylurea; amines, such as, for example, coconut fatty amine, aminosilanes and aminofunctional siloxanes; and carbamates, such as, for example, ammonium carbamate.

The acid scavengers used according to the invention are solid or liquid, preferably solid, at room temperature and ambient atmospheric pressure, i.e. from 900 to 1100 hPa.

Solid acid scavengers used according to the invention are preferably pulverulent solids, the average particle size preferably being less than 100 μm, particularly preferably less than 50 μm, in particular less than 20 μm.

The liquid acid scavengers according to the invention may be liquids having a low to a high viscosity.

The acid scavengers used according to the invention are commercially available products or can be prepared by processes customary in chemistry.

The amount of acid scavengers in the materials according to the invention may vary within wide ranges depending on the field of use or choice of the other components of the material. The amounts are preferably from 0.5 to 80 parts by weight, particularly preferably from 1 to 70 parts by weight, in particular from 2 to 60 parts by weight, based in each case on 100 parts by weight of crosslinkable material. If acidic constituents are to be used for the preparation of the crosslinkable materials, the acid scavenger must be used superstoichiometrically in correspondingly larger amounts.

The materials according to the invention may be any desired, previously known types of materials which can be crosslinked to give elastomers and are based on organosilicon compounds, such as, for example, one-component or two-component organopolysiloxane materials vulcanizable at room temperature (so-called RTV materials) or elevated temperature (so-called HTV materials), it being possible for the crosslinking to be effected by condensation, addition of Si-bonded hydrogen at an aliphatic multiple bond or by formation of free radicals using peroxides. The crosslinkable materials may be free of filler but may also contain active or inactive fillers.

The type and amount of the components usually used in such materials are already known. In this context, reference may be made, for example, to U.S. Pat. No. 5,268,441, DE-A 44 01 606, DE-A 44 05 245 and DE-A 43 36 345.

The acid scavengers used according to the invention can be mixed as desired with the other components of the crosslinkable materials according to the invention. Thus, they can be mixed in as the final step in the otherwise finally prepared silicone rubber formulation or can be incorporated during the preparation of the silicone rubber mixture. The acid scavengers can, however, also be premixed in one or more of the components used.

The mixing process for the preparation of the materials according to the invention is preferably simple mechanical mixing. Depending on the consistency and viscosity of the base medium, the mixing process can be effected on roll mills, kneaders, dissolvers, Z-mixers, ball mills or simple stirrers. For the sake of simplicity, the mixing process is preferably carried out at ambient pressure. However, mixing at reduced or superatmospheric pressure is also possible. Also for the sake of simplicity, the mixing process is preferably carried out at ambient temperature. However, it is also possible to mix at elevated temperature or with cooling.

The materials according to the invention have the advantage that they are simple to prepare and can be readily processed.

Furthermore, the materials according to the invention have the advantage that vulcanizates which have high stability to acids, i.e. remain stable for a relatively long time in an acidic environment, or can even neutralize acids in the environment can be prepared therefrom.

The materials according to the invention can be allowed to crosslink under the same conditions as crosslinkable materials known to date and based on organosilicon compounds. Preparation processes which may be used are all customary processes for processing silicone rubbers. Examples of these are calendering, compression molding, injection molding, extrusion and casting.

The present invention furthermore relates to moldings produced by crosslinking the materials according to the invention.

The moldings according to the invention may be the same moldings which have also been produced to date from crosslinkable materials based on organosilicon compounds. Examples of the moldings according to the invention are tubes, sheets, seals, injection molded parts, inner linings of pipes and coatings.

The materials according to the invention can be used, for example, for coating textile and non-textile sheet-like structures, such as woven fabrics, weft-knitted fabrics, laid webs, warp-knitted fabrics, nonwovens and felts and laid webs of metal wires or metal fibers, and on shaped articles of metal, plastic, wood, gypsum, glass, ceramic or minerals, such as masonry.

The coating according to the invention can be applied by any desired method, such as the knife coating method, dipped method, extrusion method, spraying or atomizing method. All roller coating methods, such as engraved rolls, slop-pad or application via multiroll systems, and screen printing are also possible.

The coating weight is chosen so that the amount of acid scavengers present in the coating material is at least stoichiometrically sufficient for neutralizing the amount of acid to be expected during subsequent use of the finished article. This can be calculated by simple chemical stoichiometry.

The woven fabrics coated according to the invention can be used wherever acidic gases or liquid acid are or is to be neutralized by contact with the surface and the stability of the coating in the acidic medium is to be increased.

Examples are compensators for waste gas pipes, airbags, hot air balloons, protective clothing or protective tents against acidic gases. In the industrial sector, the coated woven fabrics are advantageously used for conveyor belts, compensators, filters or insulating materials. Furthermore, substrates coated with the materials according to the invention are used in plants operated for the purification of gases and liquids. Curtains of woven fabrics coated according to the invention can neutralize acidic contents in the room air.

By crosslinking the materials according to the invention, vulcanizates which advantageously have an increased protective effect on the substrate coated therewith are obtained.

The vulcanizates according to the invention have the advantage that they have increased stability to acids.

The vulcanizates according to the invention furthermore have the advantage that acids in the environment can be neutralized.

The vulcanizates according to the invention can be used for all purposes for which vulcanizates based on organosilicon compounds have also been used to date. In particular, they are suitable for all purposes where acid resistance and the ability to neutralize acid play a role.

The present invention furthermore relates to a process for absorbing and neutralizing acids in a liquid or gaseous medium, characterized in that the moldings according to the invention are used.

The process according to the invention can be carried out at temperatures of, preferably, from −50 to 1500° C., particularly preferably from −50 to 1000° C.

The process according to the invention can be carried out at pressures of, preferably, from 100 to 200 000 hPa, particularly preferably from 100 to 50 000 hPa.

The acids absorbed or neutralized in the process according to the invention are preferably hydrogen halides, such as HCl, HBr and HF, nitrous gases and acids generated therefrom, H₂SO₃, H₂SO₄, phosphoric acids, HCN, particularly preferably hydrohalic acids and sulfur acids.

Examples of the liquid medium in which the acids are absorbed or neutralized are water, aqueous salt solutions, organic solvents, mineral oils, vegetable oils and edible oils, aqueous media being preferred.

Examples of the gaseous medium in which the acids are absorbed or neutralized are air, waste gases from incineration plants, natural gas, gases in pneumatic systems and propellants for airbags, air and nitrogen being preferred.

In the process according to the invention, the molding is simply brought into contact with the liquid or the gaseous medium.

The process according to the invention is used in particular in natural gas desulfurization, waste gas purification and reduction of the acid content in propellants in airbags.

The process according to invention has the advantage that it is simple to use, it being possible for acids to be absorbed or neutralized extremely effectively.

The process according to the invention furthermore has the advantage that no additional components (e.g. filters) are required.

The materials according to the invention which are based on organosilicon compounds may be materials which are storable in the absence of water and are crosslinkable by condensation to give elastomers on admission of water at room temperature.

The materials which are crosslinkable according to the invention by condensation are preferably those which contain

(a) organosilicon compound having condensable groups,
(b) organosilicon compound having at least three Si-bonded hydrolyzable radicals,
(c) a condensation catalyst,
(d) an acid scavenger and optionally
(e) further substances.

The materials which are crosslinkable according to the invention by condensation may be one-component materials as well as two-component materials, in the latter one component not simultaneously containing the constituents (a), (b) and (c).

Organosilicon compound (a) having condensable groups which is used is preferably that of the general formula

HO(SiR₂O)ₘSiR₂OH (I)

in which R are identical or different, optionally substituted monovalent hydrocarbon radicals and m is an integer having a value of at least 20, preferably a number from 50 to 100 000.

Although not shown by formula (I), other siloxane units, such as those of the formulae RSiO_{3/2}, R₃SiO_{1/2} and SiO_{4/2}, in which R in each case has the meaning stated above therefor, may also be present in addition to the diorganosiloxane units (SiR₂O).

The amount of such siloxane units other than diorganosiloxane units is, however, preferably not more than 10 mol %, in particular not more than 1 mol %, based in each case on the weight of organopolysiloxanes (a).

The organosilicon compounds (a) preferably have a viscosity of from 100 to 500 000 mm²/s at 25° C.

Examples of radicals R are alkyl radicals, such as the methyl, ethyl, n-propyl, isopropyl, 1-n-butyl, 2-n-butyl, isobutyl, tert-butyl, n-pentyl, isopentyl, neopentyl and tert-pentyl radicals; hexyl radicals, such as the n-hexyl radical; heptyl radicals, such as the n-heptyl radical; octyl radicals, such as the n-octyl radical and isooctyl radicals, such as the 2,2,4-trimethylpentyl radical; nonyl radicals, such as the n-nonyl radical; decyl radicals, such as the n-decyl radical; dodecyl radicals, such as the n-dodecyl radical; octadecyl radicals, such as the n-octadecyl radical; cycloalkyl radicals, such as the cyclopentyl, cyclohexyl and cycloheptyl radical and methylcyclohexyl radicals; alkenyl radicals, such as the vinyl, 1-propenyl and 2-propenyl radical; aryl radicals, such as the phenyl, naphthyl, anthryl and phenanthryl radical; alkaryl radicals, such as o-, m- and p-tolyl radicals; xylyl radicals and ethylphenyl radicals; and aralkyl radicals, such as the benzyl radical and the α- and the β-phenylethyl radical.

Radical R is preferably a radical having 1 to 18 carbon atoms, particularly preferably propyl, hexyl and octyl radicals, in particular the methyl radical.

Organosilicon compounds having at least three Si-bonded hydrolyzable groups (b) which are preferably used are silanes of the general formula

R¹₄₋ₙSiZₙ (II)

and/or partial hydrolysis products thereof having from 2 to 10 silicon atoms per molecule,
in which
R¹ may be identical or different and has a meaning stated for R.
n is 3 or 4 and
Z are identical or different hydrolyzable groups, such as the amino, amido, aminoxy or oximo group, such as, for example, —ON═C(CH₃)(C₂H₅), alkoxy, such as, for example, methoxy and ethoxy, alkoxyalkoxy, such as, for example, CH₃—O—C₂H₅—O—, or alkenyloxy, such as, for example, H₂C═(CH₃)CO—.

The hydrolyzable group Z is preferably an alkoxy or oximo group.

Radical R¹ is preferably a propyl, hexyl, octyl, vinyl or methyl radical, vinyl and methyl radicals being particularly preferred.

The organosilicon compound (b) is preferably used in an amount of from 2 to 10 parts by weight per 100 parts by weight of organosilicon compound (a).

The condensation catalyst (c) is preferably an (organo)metallic compound, such as, for example, the salts of carboxylic acids, the alcoholates and the halides of the metals Pb, Zn, Zr, Ti, Sb, Fe, Cd, Sn, Ba, Ca and Mn, such as tin(II) octanoate, dibutyltin dilaurate, octyltin triacetate, dioctyltin dioctanoate, dioctyltin diacetate, didecyltin diacetate, dibutyltin diacetate, dibutyltin dibromide, dioctyltin dilaurate, trioctyltin acetate, titanium alcoholate and organotitanium compounds having at least one Si—O—Ti bond. Condensation catalyst (c) is preferably used in an amount of from 0.1 to 2 parts by weight per 100 parts by weight of organosilicon compound (a).

Acid scavengers (d) used according to the invention are preferably used in an amount of from 2 to 80 parts by weight per 100 parts by weight of material crosslinkable by condensation reaction.

Depending on the respective use, the further substances (e) may be added to materials according to the invention which can be vulcanized to give elastomers, with the proviso that the additives (e) differ from components (a), (b), (c) and (d).

Examples of such further substances (e) are fillers, such as, for example, inactive fillers, substances for improving the surface properties, such as adhesion promoters, processing auxiliaries, such as, for example, plasticizers, pigments, soluble dyes, fragrances, fungicides, purely organic resins, corrosion inhibitors, oxidation inhibitors, heat stabilizers, solvents, compositions for influencing the electrical properties, such as conductive carbon black, flame-retardant compositions, light stabilizers and compositions for increasing the skin formation time, component (e) preferably being fillers, plasticizers and adhesion promoters.

Examples of reinforcing fillers which can be used as further substances (e) are pyrogenic or precipitated silicas having BET surface areas of at least 50 m²/g and furnace black and acetylene black, said silica fillers having a hydrophilic character or being capable of being rendered hydrophobic by known methods.

Examples of non-reinforcing fillers which can be used as further substances (e) and differ from component (d) are quartz powder, diatomaceous earth, zirconium silicate, zeolites, barium sulfate, gypsum and plastic powder, such as polyacrylonitrile powder or polytetrafluoroethylene powder. Furthermore, fibrous components, such as glass fibers and plastic fibers, may be used as fillers. The BET surface of these fillers is preferably less than 50 m²/g.

Examples of plasticizers which can be used as component (e) are polydimethylsiloxanes terminated with trimethylsilyl groups or hydroxyl groups and having a viscosity of not more than 1000 mm²/s at 25° C. or diphenylsilanediol.

Examples of adhesion promoters are aminosilanes, such as aminoethylaminopropyltriethoxysilane, or polysiloxanes which contain aminoethylaminopropylsilyloxy groups.

Examples of heat stabilizers are transition metal salts of fatty acids, such as iron octanoate, transition metal silanolates, such as iron silanolate, and cerium(IV) compounds.

The materials according to the invention which can be crosslinked by condensation preferably contain no further substances over and above the components (a) to (e).

The individual components used in the materials according to the invention which can be crosslinked by condensation may each be one type of these components as well as a mixture of at least two types of these components.

The materials according to the invention which can be crosslinked by condensation and are based on organosilicon compounds can be prepared by known processes, such as, for example, by simple mixing of the individual components. The mixing is preferably effected at room temperature and the admission of water is preferably avoided during this mixing. If desired, however, this mixing can also be effected at higher temperatures, for example at a temperature in the range from 25 to 80° C.

The usual water content of the air is sufficient for the crosslinking of the materials according to the invention. If desired, the crosslinking can also be carried out at temperatures higher than room temperature, for example at from 25 to 120° C., or at temperatures lower than room temperature, for example at from −10 to 25° C. The crosslinking can also be carried out at concentrations of water which exceed the normal water content of the air.

The materials according to the invention are suitable in particular as sealing compounds for joints and similar voids having internal widths of, for example, from 10 to 40 mm or as adhesives and cement materials, for example in window construction, or for the production of protective coverings or for the production of coverings which repel tacky substances or for other applications in which the materials known to date and crosslinkable at room temperature to give elastomers can be used, such as for the insulation of electrical or electronic apparatus, and for the coating of shaped articles of plastics, metals and elastomers and for the coating of textile sheet-like structures.

The materials according to the invention which are based on organsilicon compounds may be those which are crosslinkable by addition of Si-bonded hydrogen at an aliphatic carbon-carbon multiple bond.

The addition-crosslinkable materials according to the invention which are based on organosilicon compounds preferably contain

(1) organosilicon compounds which have SiC-bonded radicals with aliphatic carbon-carbon multiple bonds,
(2) organosilicon compounds having Si-bonded hydrogen atoms or, instead of (1) and (2),
(3) organosilicon compounds which have SiC-bonded radicals with aliphatic carbon-carbon multiple bonds and Si-bonded hydrogen atoms,
(4) a catalyst promoting the addition of Si-bonded hydrogen at an aliphatic multiple bond,
(5) an acid scavenger
and optionally
(6) further substances.

If the material according to the invention is an addition-crosslinking 2-component silicon rubber material, the two components of the silicon rubber materials according to the invention may contain all constituents in any desired combinations and ratios, with the proviso that a component does not simultaneously contain the constituents (1), (2) and (3).

The organosilicon compounds (1) are preferably linear, cyclic or branched siloxanes comprising units of the formula

R²ₛR³ₜSiO_{(4-s-t)/2} (III),

in which
R² may be identical or different and is an SiC-bonded, aliphatically unsaturated hydrocarbon radical,
R³ may be identical or different and is an optionally substituted, SiC-bonded aliphatically saturated hydrocarbon radical,
s 0, 1, 2 or 3, preferably 0, 1 or 2, and
t is 0, 1, 2 or 3, with the proviso that the sum s+t is less than or equal to 3 and at least two radicals R² are present per molecule.

The organosilicon compounds (1) preferably have an average viscosity of from 10² to 10⁶ mm²/s at 25° C.

The radical R² is preferably a hydrocarbon radical having an aliphatic multiple bond and from 2 to 18 carbon atoms, such as a vinyl, allyl, methallyl, 2-propenyl, 3-butenyl and 4-pentenyl radical, and a 5-hexenyl, butadienyl, hexadienyl, cyclopentenyl, cyclopentadienyl, cyclohexenyl, ethynyl, propargyl and 2-propynyl radical, those radicals R² having 2 to 6 carbon atoms being particularly preferred, in particular the vinyl and allyl radical.

Examples of radicals R³ are all examples of aliphatically saturated radials stated for radical R.

The radical R³ is preferably an optionally substituted aliphatically saturated, monovalent hydrocarbon radical having 1 to 18 carbon atoms, particularly preferably that having from 1 to 8 carbon atoms, in particular the methyl radical.

Particularly preferably, the organosilicon compounds (1) are linear organopolysiloxanes having a viscosity of from 200 to 10⁵ mm²/s at 25° C. and having the structure

(ViMe₂SiO_{1/2})(ViMeSiO)₀₋₅₀(Me₂SiO)₃₀₋₂₀₀₀(ViMe₂SiO_{1/2})

in which Me is a methyl radical and Vi is a vinyl radical.

Linear, cyclic or branched siloxanes comprising units of the formula

R⁴ᵤHᵥSiO_{(4-u-v)/2} (IV)

in which
R⁴ may be identical or different and has a meaning stated above for R³,
u is 0, 1, 2 or 3 and
v is 0, 1 or 2, preferably 0 or 1,
with the proviso that the sum u+v is less than or equal to 3 and on average at least two Si-bonded hydrogen atoms are present per molecule, are preferably used as organosilicon compounds (2) which have Si-bonded hydrogen atoms.

The organosilicon compounds (2) preferably have a viscosity of from 10 to 2·10⁴ mm²/s at 25° C.

The use of an organosilicon compound (2) containing three or more SiH bonds per molecule is preferred. With the use of a constituent (2) having only two SiH bonds per molecule, the organosilicon compound (1) preferably contains at least three aliphatic carbon-carbon multiple bonds per molecule. Thus, the organosilicon compound (2) is preferably used as a crosslinking agent.

The organosilicon compound (2) has a content of Si-bonded hydrogen of, preferably, from 0.002 to 1.7% by weight of hydrogen, particularly preferably from 0.1 to 1.7% by weight of hydrogen.

Particularly preferably, the organosilicon compounds (2) are organopolysiloxanes having a viscosity from 20 to 1000 mm²/s at 25° C.

The polyorganosiloxane (2) is preferably present in the curable silicone rubber material in an amount such that the molar ratio of SiH groups to radicals having an aliphatic carbon-carbon multiple bond of component (1) is from 0.5 to 5, preferably from 1.0 to 3.0.

If organosilicon compounds (3) are used they are preferably those comprising units of the formulae

R³_{f}SiO_{(4-f)/2}, R³_{g}R²SiO_{(3-g)/2} and R³ₕHSiO_{(3-h)/2},

in which R² and R³ have the meanings stated above therefor,
f is 0, 1, 2 or 3,
g is 0, 1 or 2 and
h is 0, 1 or 2,
with the proviso that at least 2 radicals R² and at least 2 Si-bonded hydrogen atoms are present per molecule.

Examples of organosilicon compounds (3) are those comprising SiO_{4/2}—, R³₃SiO_{1/2}—, R³₂R²SiO_{1/2}— and R³₂HSiO_{1/2} units, so-called MQ resins, it being possible for these resins additionally to contain R³SiO_{3/2}— and R³₂SiO units, and linear organopolysiloxanes substantially consisting of R³₂R²SiO_{1/2}—, R³₂SiO— and R³HSiO— units with R² and R³ having the abovementioned meanings.

The organosilicon compounds (3) preferably have a viscosity from 0.01 to 500 000 Pa's, particularly preferably from 0.1 to 100 000 Pa's, in each case at 25° C.

In the materials according to the invention, all hydrosilylation catalysts known to date can be used as constituent (4) which promotes the addition reaction (hydrosilylation) between the radicals having an aliphatic carbon-carbon multiple bond and Si-bonded hydrogen.

Examples of hydrosilylation catalysts (4) are metals, such as platinum, rhodium, palladium, ruthenium, and iridium, preferably platinum, which can optionally be fixed on finely divided support materials, such as active carbon, alumina or silica.

Platinum and its compounds and complexes are preferably used as catalyst (4).

The amount of catalyst (4) depends on the desired rate of crosslinking and the respective use and economic points of view. The materials according to the invention contain catalysts (4) in amounts such that a platinum content of, preferably, 0.05 to 500 ppm by weight (=parts by weight per million parts by weight), particularly preferably from 0.5 to 100 ppm by weight, in particular from 1 to 50 ppm by weight, based in each case on the total weight of the crosslinkable material, results.

The acid scavenger (5) used according to the invention is preferably one which does not inhibit the catalysts used for the addition crosslinking, such as, for example, metal oxides, such as aluminum oxide, zinc oxide, calcium oxide and magnesium oxide, metal hydroxides of the 2nd and 3rd main group and 2nd subgroup, such as aluminum hydroxide, zinc hydroxide, calcium hydroxide and magnesium hydroxide, and the hydrates thereof; salts of weak acids with strong bases, such as zinc carbonate, calcium carbonate and magnesium carbonate and the corresponding bicarbonates; ammonium salts, such as ammonium carbonate and ammonium bicarbonate; organic substances, which can neutralize acids, such as urea and tetramethylurea; and carbamates, such as, for example, ammonium carbamate.

Acid scavengers (5) used according to the invention are preferably used in an amount of from 2 to 80 parts by weight per 100 parts by weight of material crosslinkable by addition reaction.

In addition to the components (1) to (5), the curable compositions according to the invention may also contain all further substances (6) which were also used to date for the preparation of addition-crosslinkable materials, with the proviso that the further substances (6) differ from components (1) to (5).

Examples of further substances (6) are reinforcing fillers, non-reinforcing fillers, resin-like polyorganosiloxanes which differ from the siloxanes of (1), (2) and (3), dispersing auxiliaries, solvents, adhesion promoters, pigments, dyes, plasticizers, organic polymers, heat stabilizers, inhibitors and stabilizers.

Examples of customary inhibitors which can be used as component (6) are acetylenic alcohols, such as 1-ethynyl-1-cyclohexanol, 2-methyl-3-butyn-2-ol and 3,5-dimethyl-1-hexyn-3-ol, 3-methyl-1-dodecyn-3-ol, polymethylvinylcyclosiloxanes, such as 1,3,5,7-tetravinyltetramethyltetracyclosiloxane, tetravinyldimethyldisiloxane, trialkyl cyanurates, alkyl maleates, such as diallyl maleates, dimethyl maleate and diethyl maleate, alkyl fumarates, such as diallyl fumarate and diethyl fumarate, organic hydroperoxides, such as cumyl hydroperoxide, tert-butyl hydroperoxide and pinane hydroperoxide, organic peroxides, organic sulfoxides, organic amines, diamines and amides, phosphanes and phosphites, nitriles, triazoles, diaziridines and oximes.

The inhibitor content of the materials according to the invention is preferably from 0 to 50 000 ppm, particularly preferably from 50 to 2000 ppm, in particular from 100 to 800 ppm.

Examples of fillers are the examples mentioned above in relation to the condensation-crosslinkable materials.

If fillers are used, the relevant amounts are preferably from 2 to 100 parts by weight, particularly preferably from 5 to 60 parts by weight, based in each case on 100 parts by weight of component (1).

The materials according to the invention can, if required, be dissolved, dispersed, suspended or emulsified in liquids. The materials according to the invention can—in particular depending on viscosity of the constituents and filler content—have a low viscosity and be pourable, have a pasty consistency, be pulverulent or be pliable, high-viscosity materials as may be the case, as is known, with the materials frequently referred to technically as RTV-1, RTV-2, LSR and HTV. In particular, the materials according to the invention, if they have a high viscosity, can be prepared in the form of granules.

The organopolysiloxane materials according to the invention can be prepared by known processes, such as, for example, by uniform mixing of the individual components.

The components (1) to (6) used according to the invention may be in each case an individual type of such a component as well as a mixture of at least two different types of such a component.

The materials according to the invention which are crosslinkable by addition reaction preferably contain no further substances over and above the components (1) to (6).

The materials according to the invention which are crosslinkable by addition of Si-bonded hydrogen at an aliphatic multiple bond can be allowed to crosslink under the same conditions as the materials known to date which are crosslinkable by a hydrosilylation reaction. The relevant temperatures are preferably from 100 to 220° C., particularly preferably from 130 to 190° C., and the relevant pressure is from 900 to 1100 hPa. However, it is also possible to use higher or lower temperatures and pressures.

The materials according to the invention and the crosslinking products produced according to the invention therefrom can be used for all purposes for which organopolysiloxane materials crosslinkable to give elastomers or elastomers themselves have also been used to date. These comprise in particular silicone coating or impregnation of any desired substrates, the production of shaped articles, for example by the injection molding process, vacuum extrusion process, extrusion process, molding and injection molding and casting, use as sealing, embedding and potting compounds, etc.

The materials according to the invention which are based on organosilicon compounds may be materials crosslinkable using peroxides.

The materials according to the invention which are crosslinkable using peroxides and based on organosilicon compounds preferably contain

### (A) Organosilicon Compounds Comprising Units of the General Formula

R⁵ᵣSiO_{4-r)/2} (V)

in which
R⁵ may be identical or different and is a monovalent, optionally substituted hydrocarbon radical or a hydroxyl or alkoxy radical and
r is 0, 1, 2 or 3 and has an average numerical value of from 1.9 to 2.1,
(B) an agent effecting crosslinking via free radicals,
(C) an acid scavenger
and optionally
(D) further substances.

Examples of radicals R⁵ are the examples mentioned above for R. Radical R⁵ is preferably a monovalent, optionally substituted hydrocarbon radical having 1 to 18 carbon atoms, particularly preferably a monovalent, optionally substituted hydrocarbon radical having 1 to 8 carbon atoms, in particular the methyl, vinyl, phenyl or 3,3,3-trifluoropropyl radical.

The organosilicon compounds (A) are preferably organopolysiloxanes comprising units of the formula (V) in which at least 70% of all radicals R⁵ have the meaning of Si-bonded alkyl radicals, in particular methyl radicals, the units of the formula (V) preferably being diorganosiloxane units.

The terminal groups of the organosilicon compounds (A) may be trialkylsilyloxy groups, in particular the trimethylsilyloxy radical or the dimethylvinylsilyloxy radical; however, one or more of these alkyl groups may also be replaced by hydroxyl groups or alkoxy groups, such as methoxy or ethoxy radicals.

The organosilicon compounds (A) may be liquids or high-viscosity substances. The organosilicon compounds (A) preferably have a viscosity of from 10³ to 10⁸ mm²/s at 25° C.

The component (B) may be in general an agent which initiates or effects crosslinking by free radicals and which has also been used to date in materials crosslinkable using peroxides, peroxides, in particular organic peroxides, being preferred.

Examples of such organic peroxides are peroxyketal, e.g. 1,1-bis(tert-butylperoxy)-3,3,5-trimethylcyclohexane, 2,2-bis(tert-butylperoxy)butane, diacyl peroxides, such as, for example, acetyl peroxide, isobutyl peroxide, dibenzoyl peroxide, dialkyl peroxides, such as, for example, di-tert-butyl peroxide, tert-butyl cumyl peroxide, dicumyl peroxide, 2,5-dimethyl-2,5-di(tert-butylperoxy)hexane, bis-(2,4-dichlorobenzoyl) peroxide, and peresters, such as, for example, tert-butyl peroxyisopropylcarbonate.

The organopolysiloxane materials according to the invention which are crosslinkable to give elastomers contain component (B) in amounts of, preferably, from 0.4 to 2.0% by weight, particularly preferably from 0.7 to 1.5% by weight, based in each case on the total weight of the material crosslinkable using peroxides.

Preferred acid scavengers (C) used according to the invention are those which cannot catalyze premature decomposition of the peroxide used, such as, for example, the examples of acid scavengers (5) mentioned above in relation to addition-crosslinkable materials.

Acid scavengers (C) used according to the invention are preferably used in an amount of from 2 to 100 parts by weight per 100 parts by weight of material crosslinkable using peroxides.

Depending on the respective use, further substances (D) can be added to the materials according to the invention which can be vulcanized to give elastomers, with the proviso that the additives (D) differ from component (A) to (C).

Examples of such further substances (D) are fillers, plasticizers, pigments and stabilizers, such as, for example, heat stabilizers.

Examples of reinforcing and non-reinforcing fillers are the examples mentioned above for fillers in relation to condensation-crosslinkable materials.

If the materials according to the invention which can be crosslinked using peroxide contain filler as component (D), the relevant amounts are preferably from 1 to 200 parts by weight, particularly preferably from 30 to 100 parts by weight, based in each case on 100 parts by weight of organosilicon compound (A).

Examples of plasticizers and heat stabilizers which can be added as component (D) are the examples mentioned above therefor.

The materials according to the invention which can be crosslinked using peroxides preferably contain no further substances over and above this.

The respective components used for the preparation of the materials according to the invention which can be crosslinked using peroxide may be in each case an individual type of such a component as well as a mixture of at least two different types of such a component.

The organopolysiloxane materials according to the invention which can be crosslinked using peroxides can be prepared by known processes, such as, for example, by simple mixing of the individual components.

The materials according to the invention which can be crosslinked using peroxides can be allowed to crosslink under the same conditions as the materials known to date and crosslinkable using peroxides.

The materials according to the invention and the elastomers prepared according to the invention therefrom can be used for all purposes for which organopolysiloxane materials crosslinkable to give elastomers or elastomers themselves have also been used to date. The materials according to the invention are particularly suitable for production of sheets by the calendering process and for application to textile or non-textile sheet-like structures with the aid of a calender or by extrusion from a slot die.

In the examples which follow, all data on parts and percentages are based on weight, unless stated otherwise. Unless stated otherwise, the following examples are carried out at ambient atmospheric pressure, i.e. at about 1000 hPa, and at room temperature, i.e. about 20° C. or a temperature which is established on combining the reactants at room temperature without additional heating or cooling. All viscosity data mentioned in the examples are intended to be based on a temperature of 25° C.

### COMPARATIVE EXAMPLE 1

120 g of a dimethylpolysiloxane having α,ω-vinyl terminal groups and a viscosity of 20 000 mPa·s and 156 g of a dimethylpolysiloxane having α,ω-vinyl terminal groups and a viscosity of 1000 mPa·s are mixed with 55 g of a highly disperse silica having a BET surface area of 300 g/m² (commercially available from Wacker-Chemie GmbH, D-Munich under the name HDK® T 30. 0.06 g of a platinum complex of tetramethyldivinyldisiloxane, 10 g of a methylhydrogenpolysiloxane having a water content of 1.2% and a viscosity of 40 mPa·s and 1.5 g of ethynylcyclohexanol are incorporated into this mixture.

The material thus obtained is applied to woven nylon fabric by means of a knife coater and vulcanized at 150° C. in 5 minutes. The coating weight after vulcanization is 30 g/m².

### EXAMPLE 1

25 g of aluminum hydroxide having a particle size of on average 20 μm are mixed into 100 g of the material described in comparative example 1 by means of a stirrer.

The material thus obtained has a viscosity of 140 000 mPa·s and is applied to woven nylon fabric by means of a knife coater and vulcanized at 150° C. in 5 minutes. The coating weight after vulcanization is 30 g/m².

### COMPARATIVE EXAMPLE 2

164 g of a dimethylpolysiloxane having α,ω-hydroxyl terminal groups and a viscosity of 80 000 mPa·s and 96 g of water-repellant, highly disperse silica having a BET surface area of 130 g/m² (commercially available from Wacker-Chemie GmbH, D-Munich under the name HDK® H 20) are mixed in a kneader. 103 g of dimethylpolysiloxane having α,ω-hydroxyl terminal groups and a viscosity of 1000 mPa·s are incorporated into the homogeneous mixture. 1.5 g of n-propanol, 18.4 g of methyltriethoxysilane and 0.26 g of dibutyltin diacetate are then added.

The material thus obtained is applied to woven nylon fabric by means of a knife coater and vulcanized at 25° C. and 50% relative humidity for 48 hours. The coating weight after vulcanization is 30 g/m².

### EXAMPLE 2

25 g of calcium carbonate having a particle size of on average 10 μm are mixed into 100 g of the material described in comparative example 2 by means of a stirrer.

The material thus obtained is applied to woven nylon fabric by means of a knife coater and vulcanized at 25° C. and 50% relative humidity for 48 hours. The coating weight after vulcanization is 30 g/m².

### COMPARATIVE EXAMPLE 3

728 g of a dimethylpolysiloxane having α,ω-vinyl terminal groups and a Brabender plasticity of 5.2 Nm is mixed in a kneader with 10.9 g of a dimethylpolysiloxane having α,ω-hydroxyl terminal groups and a viscosity of 65 mPa·s and with 4.3 g of a polysiloxane of the formula HO[SiO(CH₃)CH═CH₂]₁₀[SiO(CH₃)₂]₄₀OH. 265 g of a highly disperse silica having a BET surface area of 150 g/m² (commercially available from Wacker-Chemie GmbH, D-Munich under the name HDK® H 15) are incorporated into this mixture. Toward the end of the mixing work, 8 g of dibenzoyl peroxide are mixed in.

The silicone rubber paste thus obtained is applied to woven nylon fabric by means of a calender and crosslinked for 3 minutes at 170° C. The coating weight after vulcanization is 40 g/m².

### EXAMPLE 3

20 g of urea are mixed into 100 g of the material described in comparative example 3 by means of a kneader.

The silicone rubber paste thus obtained is applied to a woven nylon fabric by means of a calender and crosslinked for 3 minutes at 170° C. The coating weight after vulcanization is 40 g/m².

### EXAMPLE 4

A 100 cm² piece of each of the woven fabrics coated in examples 1 to 3 and comparative examples C1 to C3 is placed in each case in a glass vessel having a capacity of 1000 ml. In each case, the glass vessel is filled with air which contains 100 ppm of HCl gas.

Thereafter, the closed vessel is stored for 3 minutes in an oven at 150° C. and then allowed to cool to room temperature and the HCl content in the gas space is determined. The results are shown in table 1.

TABLE 1

| | Woven fabric from example | | | | | |
|---|---|---|---|---|---|---|
| | C1 | 1 | C2 | 2 | C3 | 3 |
| HCl content in | 96 | 32 | 94 | 12 | 97 | 43 |
| the gas space | ppm | ppm | ppm | ppm | ppm | ppm |

### EXAMPLE 5

A safety container having a capacity of about 0.5 m³ is produced from a woven fabric coated according to example 2. The container is filled with a gas mixture comprising nitrogen and 50 ppm of HCl. The HCl content in the gas mixture decreases as a function of time.

### EXAMPLE 6

A tube having an internal diameter of 10 mm and a wall thickness of 2 mm is extruded from the material according to example 3 on an extruder and is vulcanized. A gas mixture comprising nitrogen and 50 ppm of HCl is passed through 10 m of the tube thus obtained. The HCl content at the end of the tube decreases as a function of flow velocity.

1-10. (canceled)

11. A process for absorbing and neutralizing acids, comprising contacting an acid contained in a liquid or gaseous medium with a crosslinked organosilicon composition containing at least one acid scavenger.

12. The process of claim 11, wherein said crosslinked organosilicon composition is prepared by crosslinking a crosslinkable organosilicon composition.

13. The process of claim 12, wherein the crosslinkable organosilicon composition is a condensation curable composition storable in the absence of water, comprising:
(a) organosilicon compound(s) having condensable groups,
(b) organosilicon compound(s) having at least three Si-bonded hydrolyzable radicals,
(c) at least one condensation catalyst, and
(d) at least one acid scavenger.

14. The process of claim 12, wherein the crosslinkable organosilicon composition is an addition-curable composition which is crosslinkable by addition of Si-bonded hydrogen at an aliphatic carbon-carbon multiple bond, comprising:
(1) organosilicon compound(s) which have SiC-bonded radicals with aliphatic carbon-carbon multiple bonds,
(2) organosilicon compound(s) having Si-bonded hydrogen atoms or, instead of (1) and (2),
(3) organosilicon compounds which have SiC-bonded radicals with aliphatic carbon-carbon multiple bonds and Si-bonded hydrogen atoms,
(4) at least one catalyst promoting the addition of Si-bonded hydrogen at an aliphatic multiple bond, and
(5) at least one acid scavenger.

15. The process of claim 12, wherein the crosslinkable organosilicon composition is a peroxide-curable composition comprising:
(A) organosilicon compounds comprising units of the general formula
R⁵ᵣSiO_{(4-r)/2} (V),
in which
R⁵ are identical or different and are monovalent, optionally substituted hydrocarbon radicals or hydroxyl or alkoxy radicals and
r is 0, 1, 2 or 3 and has an average numerical value of from 1.9 to 2.1,
(B) at least one agent effecting crosslinking via free radicals, and
(C) at least one acid scavenger.

16. The process of claim 12, wherein the crosslinkable organosilicon composition is applied to a fabric substrate and crosslinked.

17. The process of claim 13, wherein the crosslinkable organosilicon composition is applied to a fabric substrate and crosslinked.

18. The process of claim 14, wherein the crosslinkable organosilicon composition is applied to a fabric substrate and crosslinked.

19. The process of claim 15, wherein the crosslinkable organosilicon composition is applied to a fabric substrate and crosslinked.

20. The process of claim 11, wherein at least one acid scavenged is selected from the group consisting of hydrogen halides, nitrous gases and acids generated therefrom, H₂SO₃, H₂SO₄, phosphoric acids, and HCN.

21. The process of claim 16, wherein the fabric is a woven fabric.

22. The process of claim 12, wherein the acid scavenger comprises aluminum hydroxide.

23. The process of claim 12, wherein the acid scavenger comprises urea.

24. The process of claim 12, wherein the acid scavenger comprises calcium carbonate.

25. The process of claim 12, wherein at least one acid scavenger is selected from the group consisting of aluminum oxide, zinc oxide, calcium oxide, magnesium oxide, aluminum hydroxide, zinc hydroxide, calcium hydroxide, magnesium hydroxide, zinc carbonate, calcium carbonate, magnesium carbonate, zinc bicarbonate, calcium bicarbonate, magnesium bicarbonate, ammonium carbonate, ammonium bicarbonate, urea, tetramethylurea, ammonium carbamate, organic amines, aminosilanes, and amino-functional siloxanes.

26. The process of claim 11, wherein the acid scavenger is present in the crosslinked composition in an amount of from 2 to 60 parts by weight, based on 100 parts by weight of crosslinked composition.

27. The process of claim 11, wherein the crosslinked composition is present in the form of a tube, sheet, seal, injection molded part, coating, or pipe inner liner.
